(19) United States
(12) Patent Application Publication
(10) Pub. No.: US 2026/0046062 A1
(43) Pub. Date: Feb. 12, 2026

(54) ENCODING AND DECODING OF DATA

(71) Applicant: WAGO Verwaltungsgesellschaft mbH, Minden (DE)

(72) Inventor: Markus WEIDNER, Minden (DE)

(73) Assignee: WAGO Verwaltungsgesellschaft mbH, Minden (DE)

(21) Appl. No.: 19/294,613

(22) Filed: Aug. 8, 2025

(30) Foreign Application Priority Data
Aug. 9, 2024 (DE) 10 2024 122 891.1

(51) Int. Cl. H04L 1/00

(52) U.S. Cl. CPC H04L 1/0041; H04L 1/0076

(57) ABSTRACT

A method of encoding data, a method of decoding data, an encoder, and a decoder are provided. The decoder is configured to determine a convolutionally coded message from two or more symbol sequences, wherein each of the symbol sequences is assigned to different bit sequences according to an assignment rule and the convolutionally coded message corresponds to a bit sequence that is assigned to all symbol sequences according to the common assignment rule, and to decode the convolutionally coded message.

This nonprovisional application claims priority under 35 U.S.C. § 119(a) to German Patent Application No. 102024 122 891.1, which was filed in Germany on Aug. 9, 2024, and which is herein incorporated by reference.

### FIELD OF THE INVENTION

The present invention relates to an encoder, a decoder and methods for encoding and decoding data. In particular, the present invention relates to deriving (from the data), on the encoder side, symbol sequences which are transmitted over different transmission channels or stored in different memories, and the determining, on the decoder side, of a convolutionally coded message from the symbol sequences.

### DESCRIPTION OF THE BACKGROUND ART

Typically, cryptographic coding and channel coding, i.e. coding to increase fault tolerance (by adding systematic redundancy), are performed separately. For example, cryptographic coding and channel coding are usually performed in separate steps on the transmitter side. In the encoding process, the data to be transmitted (i.e., the plain text) is cryptographically encoded using a secret key in a first step to increase information security and is enriched with systematic redundancy through channel coding in a second step to enable error detection and/or error correction on the receiver side. The symbols generated in this way are transmitted over transmission channels and can be converted back into the original data stream in a reverse order decoding process. The same applies if the symbols are not transmitted over different transmission channels but are stored in different memories.

Convolutional coding can be used to increase fault tolerance (e.g. for channel coding). Convolutional coding distributes the input data stream to be coded smoothly and evenly across several locations in the coded output data stream by introducing redundancy. The redundancy added during coding increases the number of symbols to be transmitted/stored. This allows restoring the input data stream in the decoding process even if individual symbols in the output data stream are, to a limited extent, changed or deleted. This property is used to enable error detection and/or error correction on the receiver/reader side in data transmission/data storage.

### SUMMARY OF THE INVENTION

It is therefore an object of the present invention to provide a combination of (channel) coding, e.g. by means of a convolutional encoder, for receiver-side/reader-side error detection and/or error correction with cryptographic coding to increase information security.

A method for encoding data may comprise deriving a first symbol sequence from the data, wherein the first symbol sequence is to be transmitted over a first transmission channel or to be stored in a first memory, and deriving a second symbol sequence from the data, wherein the second symbol sequence is to be transmitted over a second transmission channel or to be stored in a second memory. Deriving the first symbol sequence may be based on a first masking of an encoding of the data by a convolutional encoder. Deriving the second symbol sequence may be based on a second masking of an encoding of the data by the convolutional encoder.

The first masking may assign a first group of state transitions of the convolutional encoder to each symbol of the first symbol sequence. The second masking may assign a second group of state transitions of the convolutional encoder to each symbol of the second symbol sequence. The first group may comprise at least one first state transition that the second group does not comprise. The second group may comprise at least one second state transition that the first group does not comprise. The first group and the second group may comprise at least one common third state transition. The first state transition, the second state transition, and the third state transition may start in the same state and end in different states. One of the state transitions may end in the state in which the state transitions started.

Furthermore, the term “transmission channel” may refer to a guided medium. For example, the first transmission channel may be a first guided medium and the second transmission channel may be a second guided medium. In particular, the first guided medium may be a first electrically conductive medium and the second guided medium may be a second electrically conductive medium. Furthermore, the first guided medium (on the sender side and/or the receiver side) may be connected to a first interface and the second guided medium (on the sender side and/or the receiver side) may be connected to a second interface, wherein the second guided medium cannot be accessed via the first interface and the first guided medium cannot be accessed via the second interface. For example, the guided media may be connected to different ports of a microcontroller acting as the sender/receiver. In addition, the term “memory” may refer to an (electronic) data storage. For example, the first memory may be a first data storage and the second memory may be a second data storage, wherein access to the first memory does not automatically enable access to the second memory and vice versa.

Furthermore, the term “convolutional encoder”, may refer to an automaton with a finite number of states, wherein a current state of the automaton is based on a previous state of the automaton and one or more bits of a bit sequence supplied to the automaton, in that the elements representing the current state are determined from the elements representing the previous state and the one or more bits. In this context, the term “state transition” may refer to the transition between two successive states (e.g. the transition from the previous state to the current state) which may be triggered by the processing of the one or more bits and thus enables an inference to be drawn about the one or more bits (particularly if the previous state or the current state is known). In this regard, it is also to be noted that a state transition may end in the state in which it started.

Furthermore, the term “encoding” may refer to an assignment of a bit sequence representing a plain text to a plurality of symbol sequences in accordance with a predetermined assignment rule. In this regard, the term “symbol” may refer to an element of a group of elements, which contains information about a sought-after state transition of the convolutional encoder which was triggered by the processing of one or more bits of the bit sequence, wherein knowing a symbol allows determining a subset of state transitions, which includes the sought-after state transition, from the set of all state transitions. Furthermore, the term “symbol sequence” may refer to a sequence of symbols containing information about the state transitions of the convolutional encoder triggered by the processing of the bits of the bit sequence. Furthermore, the term “masking” may refer to an assignment rule which is ambiguous in the reverse direction (i.e. in the direction from the symbol sequence to the bit sequence). A single masking may thus obscure a bit sequence, although the totality of all maskings may enable a unique assignment and thus the reconstruction of the bit sequence.

By using the maskings, convolutional coding may be achieved in which channel coding is combined with cryptographic coding, the output data (in the form of several symbol streams) of which is suitable for transmission over a multi-channel communication system. The convolutional coding may have the following properties:

No or only limited information about the input data (i.e. the plain text) may be obtained from any part of the output data (i.e. from a symbol sequence) transmitted over a single transmission channel. It may therefore not be possible for an attacker to completely reconstruct the input data based on a single symbol sequence which may increase the information security of the transmission.

From the totality of the portions of the output data transmitted over all transmission channels (i.e. from the totality of the symbol sequences), the input data (i.e. the plain text) may be reconstructed through combination.

When reconstructing the input data (i.e. the plain text), the decoder may, to a limited extent, have the ability to detect and/or correct symbol errors.

No secret may be required for the encoding and decoding process. Information security may result solely from the type of coding and the distribution of the output data across transmission channels, which itself does not constitute a secret.

The output data may be generated in such a way that a transmission of a redundant symbol sequence on a further transmission channel is possible, wherein the aforementioned properties continue to be valid for any of the transmission channels. By using an additional transmission channel, additional tolerance against the failure of any transmission channel may be achieved, because the symbol sequences transmitted over the remaining transmission channels may be sufficient for the decoding by the receiver.

The state transitions comprised in the first group may end in first states, wherein the first masking may assign a first symbol to at least two state transitions which start in a first one of the first states and may assign the first symbol to at least two state transitions which start in a second one of the first states.

As a result, it may not be possible to use knowledge of the first symbol to determine whether the convolutional encoder was in the first one of the first states or in the second one of the first states, nor through which of the state transitions the convolutional encoder went.

The state transitions comprised in the second group may end in second states, wherein the second masking may assign a second symbol to at least two state transitions which start in a first one of the second states and may assign the second symbol to at least two state transitions which start in a second one of the second states.

As a result, it may not be possible to use knowledge of the second symbol to determine whether the convolutional encoder was in the first one of the second states or in the second one of the second states, nor through which of the state transitions the convolutional encoder went.

The method may further comprise deriving a third symbol sequence from the data, wherein the third symbol sequence is to be transmitted over a third transmission channel or to be stored in a third memory. Deriving the third symbol sequence may be based on a third masking of the encoding of the data by the convolutional encoder. The third masking may assign a third group of state transitions of the convolutional encoder to each symbol of the third symbol sequence, wherein the first group comprises at least a fourth state transition that the third group does not comprise, the second group comprises at least a fifth state transition that the third group does not comprises, the third group comprises at least a sixth state transition that the first group and the second group do not comprise, and the third group comprises at least the common third state transition.

The third, fourth, fifth, and sixth state transitions may start in the same state and end in different states. One of the third, fourth, fifth, and sixth state transitions may end in the state in which the third, fourth, fifth, and sixth state transitions started.

The state transitions comprised in the third group may end in third states, wherein the third masking may assign a third symbol to at least two state transitions which start in a first one of the third states and may assign the third symbol to at least two state transitions which start in a second one of the third states.

As a result, it may not be possible to use knowledge of the third symbol to determine whether the convolutional encoder was in the first one of the third states or in the second one of the third states, nor through which of the state transitions the convolutional encoder went.

A method for decoding data may comprise determining a convolutionally coded message from two or more symbol sequences, wherein each of the symbol sequences is assigned to different bit sequences according to a (common) assignment rule and the convolutionally coded message corresponds to a bit sequence that is assigned to all symbol sequences according to the (common) assignment rule, and decoding the convolutionally coded message.

In this context, the term “common assignment rule” may refer to an assignment rule which, based on the maskings, assigns symbols which are to be transmitted over the transmission channels to each state transition of the convolutional encoder. The common assignment rule may be represented, for example, in the form of a state diagram in which the symbols which are to be transmitted over the different transmission channels are assigned to each state transition, such that the symbol sequences can be determined by following a path through the state diagram.

An encoder may be configured to derive a first symbol sequence from data to be encoded and transmit the first symbol sequence over a first transmission channel or store the first symbol sequence in a first memory and derive a second symbol sequence from the data to be encoded and transmit the second symbol sequence via a second transmission channel or store the second symbol sequence in a second memory, wherein deriving the first symbol sequence is based on a first masking of an encoding of the data by a convolutional encoder, wherein deriving the second symbol sequence is based on a second masking of the encoding of the data by the convolutional encoder, wherein the first masking assigns a first symbol to a first group of state transitions of the convolutional encoder, wherein the second masking assigns a second symbol to a second group of state transitions of the convolutional encoder, wherein the first group and the second group comprise at least one state transition which is comprised in both groups, comprise at least one state transition which is only comprised in the first group, and comprise at least one state transition which is only comprised in the second group.

The first group and the second group may comprise at least one state transition that is comprised in both groups, at least one state transition that is comprised only in the first group, and at least one state transition that is comprised only in the second group.

The state transitions comprised in the first group may end in first states, wherein the first masking may assign a first symbol to at least two state transitions which start in a first one of the first states and may assign the first symbol to at least two state transitions which start in a second one of the first states.

The state transitions comprised in the second group may end in second states, wherein the second masking may assign a second symbol to at least two state transitions which start in a first one of the second states and may assign the second symbol to at least two state transitions which start in a second one of the second states.

The encoder may further be configured to determine a third symbol sequence on the basis of the first and second symbol sequence and transmit the third symbol sequence over a third transmission channel or store the third symbol sequence in a third memory.

Each symbol of the third symbol sequence may be assigned a third group of state transitions of the convolutional encoder. The first group may comprise at least one fourth state transition that the third group does not comprise. The second group may comprise at least one fifth state transition that the third group does not comprise. The third group may comprise at least one sixth state transition that the first group and the second group do not comprise. The third group may comprise at least the common third state transition. The third, fourth, fifth, and sixth state transitions may start in the same state and end in different states.

The state transitions comprised in the third group may end in third states. A third symbol may be assigned to at least two state transitions which start in a first one of the third states and the third symbol may be assigned to at least two state transitions which start in a second one of the third states.

A decoder may be configured to determine a convolutionally coded message from two or more symbol sequences, wherein each of the symbol sequences is assigned to different bit sequences according to a (common) assignment rule and the convolutionally coded message corresponds to a bit sequence that is assigned to all symbol sequences according to the (common) assignment rule, and to decode the convolutionally coded message.

Furthermore, it is understood that all features described in connection with the encoder and the decoder may also be features of the methods and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a convolutional encoder;

FIG. 2 shows a finite automaton representing the convolutional encoder shown in FIG. 1;

FIG. 3 shows a communication system;

FIG. 4 shows a state diagram of a finite state automaton representing a convolutional encoder;

FIG. 5a shows an illustration of data which is to be encoded;

FIG. 5b shows an illustration of the first, second, and third masking;

FIG. 5c shows another illustration of the first, second, and third masking;

FIG. 5d shows an illustration of the decoding;

FIG. 6 shows symbol pairs of the state transitions of the finite automaton shown in FIG. 4;

FIG. 7 shows state types and incoming and outgoing state transitions;

FIG. 8 shows a flowchart of a method of encoding data; and

FIG. 9 shows a flowchart of a method of decoding data.

### DETAILED DESCRIPTION

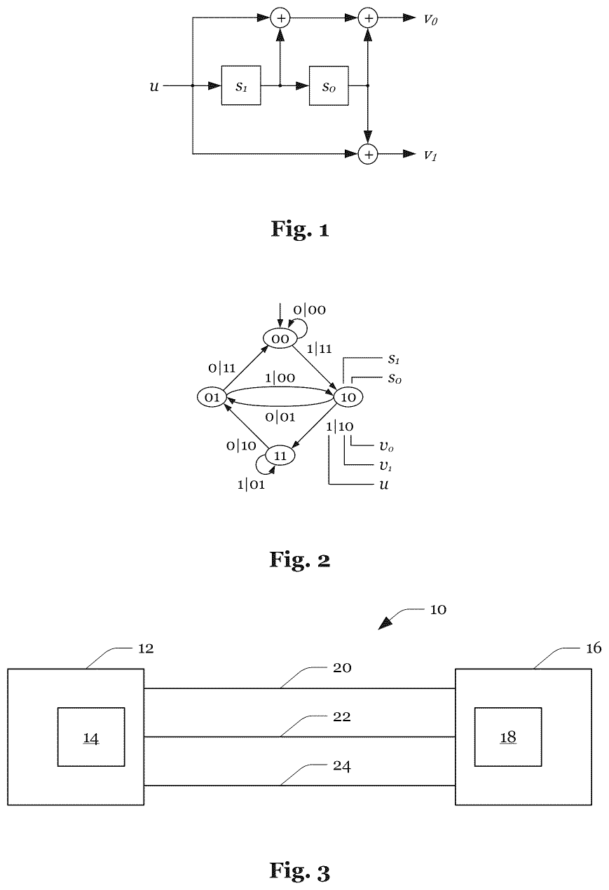

FIG. 1 shows a shift register representation of a binary convolutional encoder. It comprises two bit positions s₀ and s₁, into which the bits u of the data to be encoded are shifted one after the other. Each new input bit u is logically processed with the stored values s₀ and s₁ in accordance with the arrangement shown, generating two new output bits v₀ and v₁. These output bits v₀ and v₁ and the following bit pairs are dependent on each other by the influence length of the convolutional encoder, which is determined by the number of internal bit positions, thus realizing the distribution of the information content over several output bits.

FIG. 2 shows a representation corresponding to the shift register representation in the form of a finite state automaton. In this representation, the states of the automaton are marked with the values of the bits s₁ and s₀ and the state transitions between the states are marked with the value of the input bit u, which triggers the respective state transition. Furthermore, each state transition is assigned the output bits v₀ and v₁, which are generated by the input bit u. The code generated by the convolutional encoder has a free distance (Hamming distance) of d_{f}=5. This means that for any two paths from one state to another state or the same state, the symbol sequences of the two paths differ in at least 5 symbols.

FIG. 3 shows a system 10 with a sender 12 having an encoder 14 and a receiver 16 having a decoder 18. Sender 12 and receiver 16 are connected via three transmission channels 20, 22, and 24. If the encoder 14 were designed similar to the convolutional encoder described with reference to FIG. 1 and FIG. 2, the binary symbols v₀ and v₁ could not (easily) be divided between two of the transmission channels 20, 22, and 24 so that the path through the states of the automaton cannot be traced by observing the symbols v₀ and v₁ of only one of the transmission channels 20, 22, and 24.

In particular, the information security of the system 10 cannot be increased (solely) by an alternating assignment of the symbols v₀ and v₁ to the transmission channels 20 and 22, because it is irrelevant which of the symbols v₀ and v₁ is known. Starting from a known state, the (additional) knowledge of one of the two symbols v₀ and v₁ is sufficient to determine the subsequent state transition, whereby the subsequent state is also known. Even a pairwise alternating assignment of the symbol pairs to the transmission channels 20 and 22 would not (readily) increase information security, because the path is revealed by observing several state transitions. A pseudorandom distribution based on a secret key would increase information security, but at the cost of using a secret key.

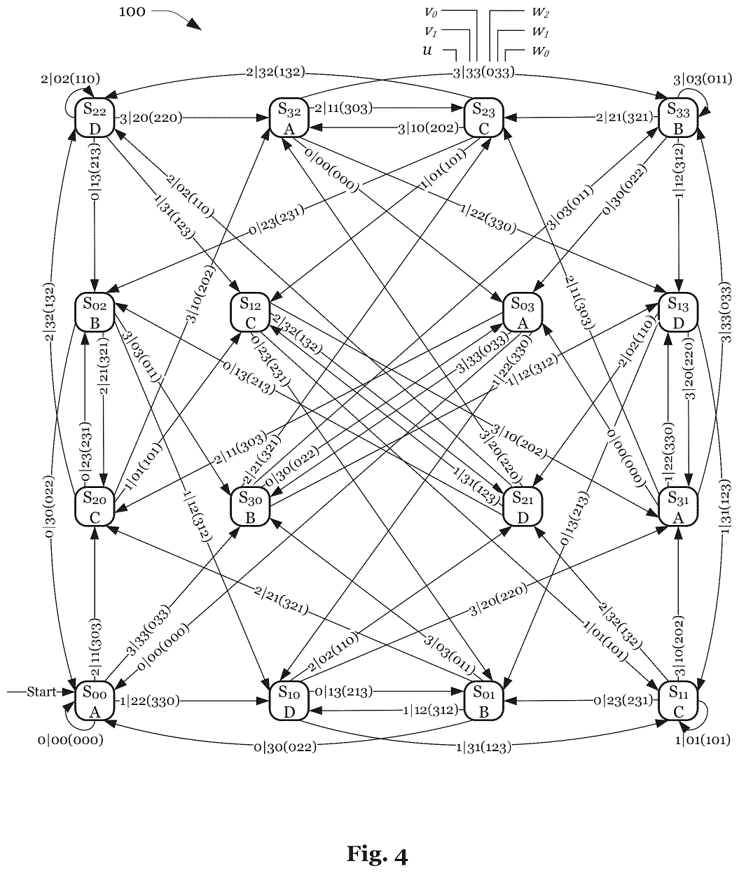

However, the information security of the system 10 may be increased by transmitting symbols over two of the transmission channels 20, 22, and 24 if the encoder 14 configuration follows the quaternary convolutional encoder 100 shown in FIG. 4. The quaternary convolutional encoder 100 has two symbol locations for storing the bit stream of the input data (memory depth m=2), which, when using a symbol alphabet of size q=4, results in a total of q^{m}=16 states the convolutional encoder 100 can be in. In addition, four state transitions start in each state and four state transitions end in each state, one per input symbol u={0,1,2,3}. To increase the information security of the system 10 when transmitting the output symbols w₂={0,1,2,3}, w₁={0,1,2,3}, and w₀={0,1,2,3}, the output symbols w₂, w₁, or w₀ may be assigned to the state transitions in such a way that in each state two of the four state transitions use the same output symbol (0, 1, 2 or 3) on one of the transmission channels 20, 22, and 24. Observing the output symbols w₂, w₁, or w₀ on one of the transmission channels 20, 22, and 24 therefore may not provide any clear information about the state transition. Rather, this only exclude half of the succeeding states. In order for the state transitions to be unambiguous for the decoder 28 which receives the symbols of two transmission channels 20, 22, and 24, the pairs of state transitions that use the same output symbol w₂, w₁, or w₀ must be different on both transmission channels 20, 22 and 24.

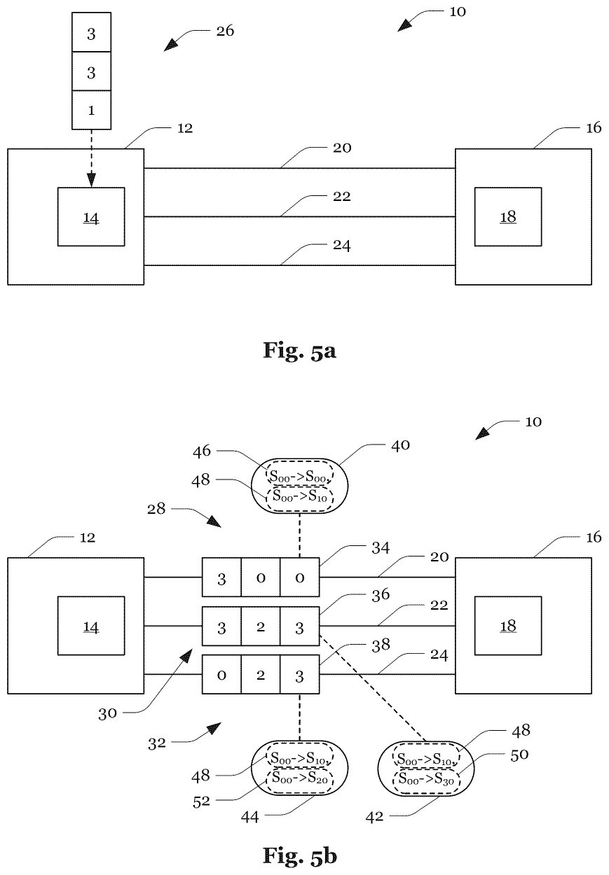

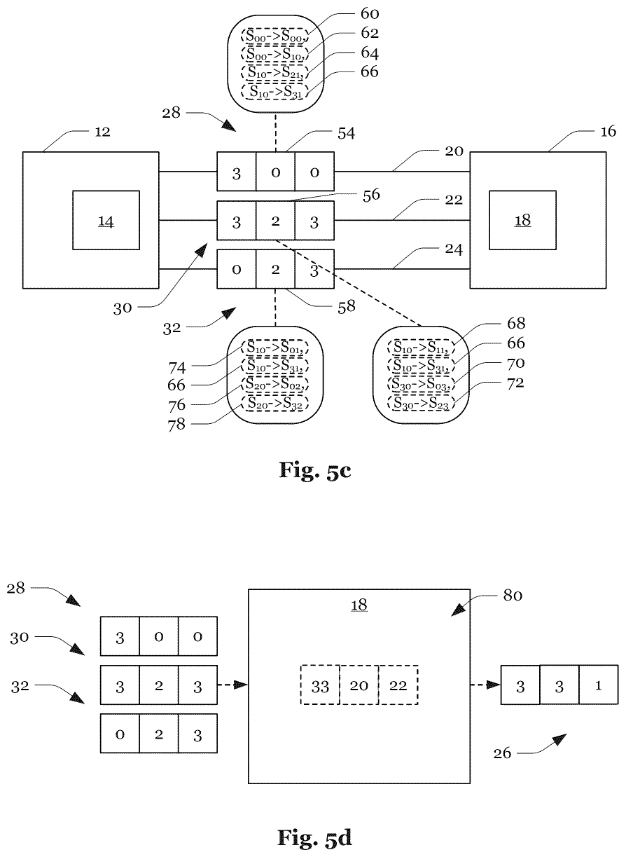

If, for example, as illustrated in FIG. 5a, the data 26 formed of the symbol sequence “1-3-3” is input into the encoder 14, the encoder 14, which is configured in accordance with the quaternary convolutional encoder 100 shown in FIG. 4, derives the symbol sequences 28, 30, and 32 shown in FIG. 5b, wherein the first symbol sequence 28 “0-0-3” is transmitted to the receiver 16 over the first transmission channel 20, the second symbol sequence 30 “3-2-3” is transmitted over the second transmission channel 22, and the third symbol sequence 32 “3-2-0” is transmitted over the third transmission channel 24. As illustrated by the first symbols 34, 36, and 38 of the symbol sequences 28, 30, and 32 in FIG. 5b, the first symbols 34, 36, and 38 are assigned groups 40, 42, and 44 of state transitions 46, 48, 50, and 52, wherein each of the groups 40, 42, and 44 comprises the common state transition 48 and a further state transition 46, 50, and 52 which the others of the groups 40, 42, and 44 do not comprise.

To increase the information security of the system 10, it may be further advantageous if an observer cannot retroactively exclude state transitions from a sequence of several output symbols w₂, w₁, or w₀ on one of the transmission channels 20, 22, and 24 to such an extent that only one possibility remains for a state transition and thus the input symbol u is revealed. Therefore, it may be advantageous if, for an output symbol w₂, w₁, or w₀, which marks a transition from one state to possible subsequent states, that output symbols w₂, w₁, or w₀, which are available when starting in the subsequent states are identical, because then the observation of the subsequent transition cannot be used to infer the previous state transition.

This is illustrated in FIG. 5c based on an example. Symbol 54 is assigned to state transitions 60 and 62 which start in state S₀₀, and to state transitions 64 and 66 which start in state S₁₀. Symbol 56 is assigned to state transitions 68 and 66 which start in state S₁₀, and to state transitions 70 and 72 which start in state S₃₀. Symbol 58 is assigned to state transitions 74 and 66 which start in state S₁₀, and to state transitions 76 and 78 which start in state S₂₀. As illustrated in FIG. 5d, the convolutionally coded message 80 may then be determined in the decoder 18 from the symbol sequences 28, 30, and 32 and the data 26 may be determined by decoding the convolutionally coded message 80.

For such a construction, the output symbols w₂, w₁, or w₀ may be calculated from the quaternary code symbols v₀ and v₁. Because they are sent on the individual transmission channels 20, 22, and 24, they are also referred to as channel symbols w₂, w₁, or w₀ in the following. The channel symbols w₁ or w₀ for the transmission channels 20 and 22 are calculated by swapping the code bits as

$${w}_{0} = \{ {v}_{1}^{( 0 )} , {v}_{0}^{( 0 )} \} und {w}_{1} = \{ {v}_{1}^{( 1 )} , {v}_{0}^{( 1 )} \} . \qquad Formula 1$$

For the (optional) third transmission channel 24, the channel symbol w₂ may be calculated by

$${w}_{2} = {w}_{0} ⊕ {w}_{1} \qquad Formula 2$$

Hence, the code symbols v₀ and v₁ may be reconstructed from any two of the three channel symbols. The calculation also ensures that when the symbol w₂ is used for decoding, a single bit error (for example caused during data transmission) destroys only one of the quaternary code symbols v₀ and v₁ and not both.

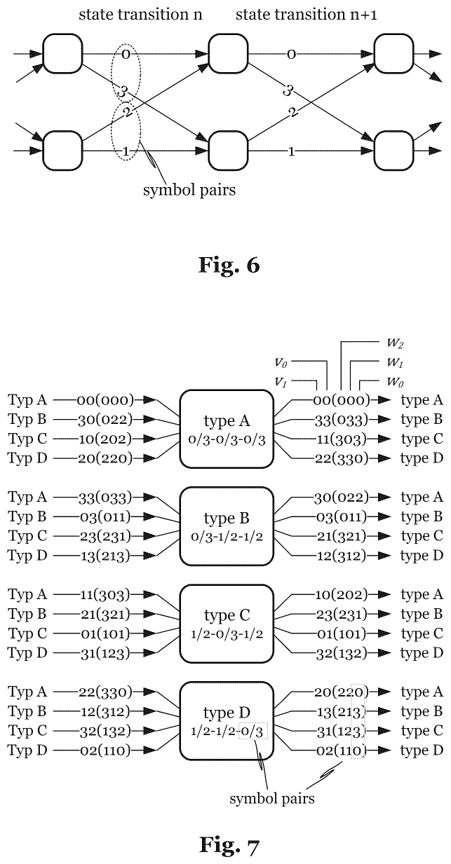

It may now be arbitrarily specified that the transitions starting in a state use either one of the channel symbol pairs w={0,3} or w={1,2} for a transmission channel. Two of the four transitions each are assigned the same channel symbol. Furthermore, it may be specified that transitions with the channel symbols w={0,2} end in a state starting in which the symbol pair 0/3 is used. Accordingly, transitions with the channel symbols w={1,3} may end in a state starting in which the symbol pair 1/2 is used. This is schematically illustrated in FIG. 6, wherein it has been omitted for the sake of clarity that several transitions with the same symbol start in each state and each end in two different target states.

To achieve these conditions, the exclusive construction of the convolutional encoder 100 through generator polynomials may be abandoned. Conversely, the structure formed of states, transitions, and their associated code symbols v₀ and v₁ may be retained. However, the code symbols v₀ and v₁ may be assigned directly to the transitions, as shown in FIG. 7. In particular, the 16 combinations of code and channel symbols (v₁v₀=00,01,02 . . . 32,33) resulting from Formula 1 and Formula 2 may be sorted such that they each have two identical channel symbols per transmission channel. The pairs may also be offset across four combinations on the transmission channels. Four combinations may be assigned to each of four state types.

This may result in the state types A to D shown in FIG. 7. The following properties may be observed:

For each state type and each transmission channel, only two of the four channel symbols may be used to indicate the outgoing transition.

The two channel symbols used may come from either the 0/3 or 1/2 pair.

The pairs may be offset across the three transmission channels so that each transition is unique with two of the three channel symbols.

The transitions may end in a state type as shown in FIG. 6. This may allow the channel symbol pair of the subsequent transition to be predicted. This may apply to all three transmission channels, although the pairs may be offset.

In total, all 16 possible combinations of code symbols vᵢv₀ may be used.

Each state type may have four transitions to all four state types and each state type may be reached from all four types. The states or types may therefore all be connected to one another.

The state types may now be assigned to the q^{m}=16 states. Due to the structure in FIG. 7, 4 states may be assigned the same type. This may result, for example, in the convolutional encoder 100 from FIG. 4, the states of which are labeled with the respective state type. A starting state may, for example, be state Sₒₒ. Based on the code symbols that can be calculated from the channel symbols, the code has a free distance (Hamming distance) of d_{f}=3 and is therefore suitable for error correction or error detection.

In addition, the use of the convolutional encoder 100 provides (additional) cryptographic protection in that an attacker who can only observe one of the transmission channels 20, 22, 24 cannot unambiguously determine the state in which the convolutional encoder 100 is (after the first transition). In particular, there are always several possible transitions and thus data symbols to choose from that may be the cause of the observed channel symbol. This means that the data symbol can no longer be clearly identified. Since the channel symbols do not allow any prediction of the expected channel symbol pair of the subsequent transition, no relationship between the individual data symbols can be determined.

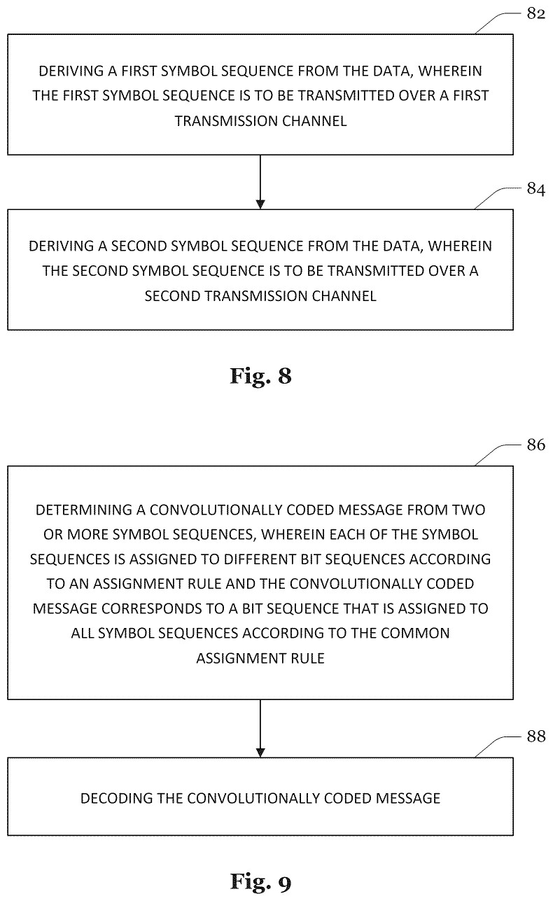

FIG. 8 shows a flowchart of a method of encoding the data 26. The method comprises a step 82 of deriving the symbol sequence 28 from the data 26 and a step 84 of deriving 84 the symbol sequence 30 from the data 26. The symbol sequences 28 and 30 are then transmitted over the transmission channels 20 and 22 to the receiver 16, in which the symbol sequences 28 and 30 are decoded.

FIG. 9 shows a flowchart of a method of decoding the symbol sequences 28 and 30. The method comprises a step 86 of determining the convolutionally coded message 80 from the symbol sequences 28 and 30 and a step 88 of decoding the convolutionally coded message 80.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method of encoding data, the method comprising:
deriving a first symbol sequence from the data, wherein the first symbol sequence is to be transmitted over a first transmission channel or to be stored in a first memory; and
deriving a second symbol sequence from the data, wherein the second symbol sequence is to be transmitted over a second transmission channel or to be stored in a second memory,
wherein the deriving of the first symbol sequence is based on a first masking of an encoding of the data by a convolutional encoder,
wherein the deriving of the second symbol sequence is based on a second masking of the encoding of the data by the convolutional encoder,
wherein the first masking assigns a first group of state transitions of the convolutional encoder to each symbol of the first symbol sequence,
wherein the second masking assigns a second group of state transitions of the convolutional encoder to each symbol of the second symbol sequence,
wherein the first group comprises at least one first state transition that the second group does not comprise,
wherein the second group comprises at least one second state transition that the first group does not comprise,
wherein the first group and the second group comprise at least one common third state transition, and
wherein the first, second, and third state transitions start in a same state and end in different states.

2. The method of encoding data of claim 1, wherein the state transitions comprised in the first group end in first states, wherein the first masking assigns a first symbol to at least two state transitions which start in a first one of the first states and assigns the first symbol to at least two state transitions which start in a second one of the first states.

3. The method of encoding data of claim 1, wherein the state transitions comprised in the second group end in second states, and wherein the second masking assigns a second symbol to at least two state transitions which start in a first one of the second states and assigns the second symbol to at least two state transitions which start in a second one of the second states.

4. The method of encoding data of claim 1, further comprising:
deriving a third symbol sequence from the data,
wherein the third symbol sequence is to be transmitted over a third transmission channel or to be stored in a third memory,
wherein the deriving of the third symbol sequence is based on a third masking of the encoding of the data by the convolutional encoder,
wherein the third masking assigns a third group of state transitions of the convolutional encoder to each symbol of the third symbol sequence,
wherein the first group comprises at least one fourth state transition that the third group does not comprise,
wherein the second group comprises at least one fifth state transition that the third group does not comprise,
wherein the third group comprises at least one sixth state transition that the first group and the second group do not comprise,
wherein the third group comprises at least the common third state transition, and
wherein the third, fourth, fifth, and sixth state transitions start in the same state and end in different states.

5. The method of encoding data of claim 4, wherein the state transitions comprised in the third group end in third states, and wherein the third masking assigns a third symbol to at least two state transitions which start in a first one of the third states and assigns the third symbol to at least two state transitions which start in a second one of the third states.

6. A method of decoding data, the method comprising:
determining a convolutionally coded message from two or more symbol sequences, each of the symbol sequences being assigned to different bit sequences according to an assignment rule and the convolutionally coded message corresponding to a bit sequence that is assigned to all symbol sequences according to the common assignment rule; and
decoding the convolutionally coded message.

7. An encoder configured to:
derive a first symbol sequence from data to be encoded and transmit the first symbol sequence over a first transmission channel or store the first symbol sequence in a first memory; and
derive a second symbol sequence from the data to be encoded and transmit the second symbol sequence via a second transmission channel or store the second symbol sequence in a second memory,
wherein the deriving of the first symbol sequence is based on a first masking of an encoding of the data by a convolutional encoder,
wherein deriving the second symbol sequence is based on a second masking of the encoding of the data by the convolutional encoder,
wherein the first masking assigns a first symbol to a first group of state transitions of the convolutional encoder,
wherein the second masking assigns a second symbol to a second group of state transitions of the convolutional encoder, and
wherein the first group and the second group:
comprise at least one state transition which is comprised in both groups;
comprise at least one state transition which is only comprised in the first group; and
comprise at least one state transition which is only comprised in the second group.

8. The encoder of claim 7, wherein the state transitions comprised in the first group end in first states, and wherein the first masking assigns a first symbol to at least two state transitions which start in a first one of the first states and assigns the first symbol to at least two state transitions which start in a second one of the first states.

9. The encoder of claim 7, wherein the state transitions comprised in the second group end in second states, and wherein the second masking assigns a second symbol to at least two state transitions which start in a first one of the second states and assigns the second symbol to at least two state transitions which start in a second one of the second states.

10. The encoder of claim 7, wherein the encoder is further configured to:
determine a third symbol sequence on the basis of the first and second symbol sequence and transmit the third symbol sequence over a third transmission channel or store the third symbol sequence in a third memory.

11. A decoder configured to:
determine a convolutionally coded message from two or more symbol sequences, wherein each of the symbol sequences is assigned to different bit sequences according to an assignment rule and the convolutionally coded message corresponds to a bit sequence that is assigned to all symbol sequences according to the common assignment rule; and
decode the convolutionally coded message.
